(19) United States
(12) Patent Application Publication
(10) Pub. No.: US 2026/0264624 A1
(43) Pub. Date: Sep. 10, 2026

(54) FRONT CAMERA ARRANGEMENT FOR A MOTOR VEHICLE AND MOTOR VEHICLE

(71) Applicant: Valeo Schalter und Sensoren GmbH, Bietigheim-Bissingen (DE)

(72) Inventors: Marek Stepan, Prague (CZ); Pavel Holecek, Prague (CZ); Petr Sramek, Prague (CZ); Tomas Vajdiak, Prague (CZ); Donald Peyrot, Prague (CZ)

(73) Assignee: Valeo Schalter und Sensoren GmbH, Bietigheim-Bissingen (DE)

(21) Appl. No.: 19/165,852

(22) PCT Filed: Feb. 29, 2024
(86) PCT No.: PCT/EP2024/055173

§ 371 Date: Sep. 16, 2025

(30) Foreign Application Priority Data
Mar. 16, 2023 (DE) 10 2023 106 661.7

(51) Int. Cl. B60R 11/04; B60R 11/00; G02B 3/00; G02B 3/08; G02B 5/04; G02B 13/06

(52) U.S. Cl. CPC B60R 11/04; G02B 3/08; G02B 5/045; G02B 13/06; B60R 2011/0026; B60Y 2200/14; G02B 2003/0093

(57) ABSTRACT

Described is a vehicle front camera arrangement including a camera and an optical device arranged in a field of view of the camera. The optical device has a non-bending portion designed to leave a propagation direction of light passing through it unchanged and a bending portion designed and arranged to change a propagation direction of light passing through it, where an angle the propagation direction includes with a direction of an optical axis of the camera pointing towards an image sensor of the camera is increased. The non-bending portion covers a first part of a vertical field of view of the camera, and the bending portion covers a second part of the vertical field of view, which is adjacent to the first part.

The present invention is directed to a front camera arrangement for being mounted to a motor vehicle comprising a camera, and to a motor vehicle comprising such front camera arrangement.

Cameras depicting an exterior environment of a motor vehicle, in particular front cameras, which are mounted to a windshield of the vehicle, may be used for various driver assistance functions or other functions for partially or fully automated driving of a motor vehicle. Such front cameras are for example designed as rectilinear cameras. One drawback of rectilinear cameras is, however, that their field of view, in particular vertical field of view, is rather limited. Consequently, a certain region in front of the motor vehicle close to the road surface is not captured. The size of this blind area depends on the mounting height of the camera from the road surface. For passenger cars, where the mounting height is relatively low, the blind area may be acceptable for many applications. For other types of vehicles, where the mounting position is higher, such as busses or trucks, the blind area is increased, which may give rise to a reduced reliability of the associated driver assistance functions or vehicle guidance functions making use of camera images generated by that camera.

One way to increase the vertical field of view would be to use non-rectilinear cameras, such as fisheye cameras, instead of rectilinear cameras. However, one drawback of fisheye cameras or other non-rectilinear cameras is the large amount of distortion due to the specific design of such cameras. This may make it necessary to adjust computer algorithms using the cameras on the one hand and, on the other hand, in case the camera images are to be displayed to a user or driver of the vehicle, an increased effort has to be made for undistorting the images.

Document U.S. Pat. No. 11,391,820 B2 describes a technology for enhancing or extending the field of view of sensors for vehicles configured to operate in an autonomous driving mode.

Therein, one or more mirrors are used to reflect or redirect beams emitted from onboard sensors that would otherwise be wasted, for instance due to obstruction by a portion of the vehicle or because they are emitted at high pitch angles to the side. The mirrors are also used to redirect incoming beams from the external sensor environment toward one or more of the onboard sensors. The mirrors may, however, may lead to obstructions in the field of view of the sensors.

It is an objective of the present invention to provide a possibility to extend a vertical field of view of a front camera arrangement for a motor vehicle such that a blind area in front of the vehicle is reduced.

This objective is achieved by the respective subject matter of the independent claims. Further implementations and preferred embodiments are subject matter of the dependent claims.

The invention is based on the idea to place an optical device in the field of view of the camera, which comprises a non-bending portion that does not change a propagation direction of light passing through the optical element and a bending portion that does change the propagation direction. The non-bending portion and the bending portion are arranged to cover respective different adjacent parts of the vertical field of view of the camera.

According to a first aspect of the invention, a front camera arrangement for being mounted to a motor vehicle is provided. The front camera arrangement comprises a camera and an optical device, which is arranged in a field of view of the camera, in particular is arranged completely within the field of view of the camera. The optical device comprises a non-bending portion, in particular a non-light-bending portion, which is designed such as to leave a propagation direction of light passing through the non-bending portion unchanged. The optical device comprises a bending portion, in particular a light-bending portion, which is designed and arranged with respect to the camera such as to change a propagation direction of light passing through the bending portion. Therein, a vertical angle of the propagation direction includes with a direction of an optical axis of the camera pointing towards an image sensor of the camera is increased when the propagation direction of the light passing through is changed. The optical device is arranged with respect to the camera such that the non-bending portion of the optical device covers a first part of a vertical field of view of the camera and the bending portion of the optical device covers a second part of the vertical field of view, wherein the second part is adjacent to the first part.

Since the optical device is placed within the field of view of the camera, in particular completely within the field of view of the camera, all light that enters the camera, in particular a lens unit of the camera, from an environment of the camera, in particular from an outer environment of the motor vehicle, when the camera is mounted to the motor vehicle, necessarily has to pass the optical device, and in particular has to pass either the bending portion or the non-bending portion.

The field of view of the camera can for example be defined as a composition of the vertical field of view and a corresponding horizontal field of view. The vertical field of view is for example defined as an angular range regarding an optical center of the camera in a plane, which comprises the optical axis of the camera as well as a predefined vertical direction. The vertical direction corresponds to the direction of a height axis of the motor vehicle when the camera arrangement is mounted at the motor vehicle. In other words, the vertical direction corresponds to a direction, which is essentially perpendicular to a road surface the motor vehicle is located on. When the front camera arrangement is not or not yet mounted to the motor vehicle, the vertical direction corresponds to an intended vertical direction according to the intended mounting position and orientation of the front camera arrangement and, in particular the camera, on the motor vehicle. The vertical field of view is then defined analogously. In particular, the camera has a predefined mounting orientation with regard to the motor vehicle, in particular with regard to the height axis of the motor vehicle. Consequently, the arrangement of the optical device with respect to the camera can be derived from the mounting orientation such that the features of the front camera arrangement according to the invention as described are realized once the front camera arrangement is mounted in the intended manner and in particular the camera is mounted in the predefined mounting orientation to the motor vehicle.

The expressions bending and non-bending refer here and in the following to the described change or absence of change of the propagation direction of light passing through the respective portion of the optical device. In particular, the non-bending portion leaves the propagation direction of the light unchanged in the vertical plane as well as in the corresponding horizontal plane, which is perpendicular to the vertical plane and comprises the optical axis of the camera. The bending portion changes the propagation direction at least in the vertical plane. However, in some implementations, the propagation direction may additionally be changed by the bending portion also in the horizontal plane.

The vertical angle, consequently, corresponds to an angle the light propagation direction includes with the optical axis in the vertical plane. The vertical angle is increased by the bending portion. Therein, the direction of the optical axis as mentioned above points towards the image sensor of the camera and also the propagation direction is defined such that it points to the image sensor rather than away from the image sensor. It is noted that the vertical angle is defined with a sign. In particular, the absolute value of the vertical angle is not necessarily increased by the bending portion but can, depending on the propagation direction and arrangement, also be decreased. The vertical angle is defined such that it is 0° in case the propagation direction is parallel to the optical axis. In particular, before passing the bending portion, the vertical angle lies in the range [−90°, 90°].

Depending on the actual implementation of the optical device, the bending portion and the non-bending portion may be made of one piece or may be arranged adjacent to each other such that they cover the respective first and second part of the vertical field of view, respectively. The non-bending portion covers the first part of the vertical field of view. Consequently, light that propagates within the first part of the vertical field of view after passing the optical device necessarily has passed through the non-bending portion. On the other hand, the bending portion covers the second part of the vertical field of view. Therefore, light that enters the camera, in particular the lens unit of the camera, in the second part of its vertical field of view necessarily has passed the bending portion before.

The change of the propagation direction due to the bending portion may be caused by diffractive effects or by refractive effects or by a combination of both.

According to a front camera arrangement according to the invention, the vertical field of view of the front camera arrangement is increased compared to the vertical field of view of the camera without the optical device. Due to the combination of the bending portion and the non-bending portion, a part of the resulting image captured by the camera or the image sensor, respectively, is not distorted or essentially not distorted, since the corresponding light has passed through the non-bending portion. Another part of the image, which has passed the bending portion, is distorted like for example for a fisheye type of lens. In return, however, the vertical field of view is expanded or increased such that this amount of distortion may be accepted. In particular, since a significant part of the image is still undistorted using the optical device as described for the invention is advantageous compared to the use of a regular fisheye camera.

In particular, the second part of the vertical field of view lies below the first part of the vertical field of view in the sense that the overall field of view is extended towards the road surface when the front camera arrangement is mounted to the vehicle compared to the first part of the vertical field of view. In other words, the bending portion is arranged below the non-bending portion when mounted to the motor vehicle or, in yet other words, the bending portion is arranged closer to the road surface in this case.

According to several implementations of the front camera arrangement, the optical device is implemented as a metalens. Therein, the bending portion corresponds to a portion of the metalens with a structured surface, in particular a micro-structured surface.

The non-bending portion corresponds to a surface of the metalens, which is designed such as to leave the propagation direction of light passing through the non-bending portion unchanged, for example an unstructured surface.

In implementations where the optical device is implemented as a metalens, suitable design for the bending portion may be as described for the metalens presented in the publication M. Y. Shalagienov et. al.: “Single-element Diffraction-limited Fisheye Metalens”, Nano letters 2020, 20, 10, 7429.

Consequently, the bending portion of the optical device can be designed using a structuring as described for that metalens, while the non-bending portion can be designed as a flat piece of material without surface structuring or with non-bending surface structures. Consequently, the metalens can significantly increase the vertical and, in particular, also the horizontal field of view in the region corresponding to the bending portion, while the light passing through the non-bending portion is still unaffected. The advantages of using such a hybrid metalens design include the fact that the metalens can be produced in a very flat way such that the required space of the optical device is reduced. furthermore, the concept of the metalens surface structuring used for the bending portion allows to flexibly adjust the change of the propagation direction to an arbitrary degree.

According to several implementations, the non-bending portion corresponds to a flat pane, in particular an unstructured flat pane, of an optically transparent material, in particular glass or a plastic material.

According to several implementations, the bending portion comprises an array of prisms, in particular micro prisms.

In particular, the prisms of the array of prisms are formed on a first side of the bending portion and the bending portion comprises a plane surface on a second side, which is opposite to the first side.

The bending portion may for example be essentially flat, wherein the first side of the bending portion is structured, in particular micro-structured, to form the array of prisms, in particular micro-prisms. Even though the structuring may be denoted as micro-structuring and the prisms may be denoted as micro-prisms, the smallest physical dimensions, for example the side lengths of the base faces of the prisms, may lie in the order of several micrometers up to several millimeters, for example from 1 μm to 5 mm.

The prisms are, in particular, formed as non-truncated prisms, in particular as right prisms, for example as triangular right prisms. In other words, each prism comprises for example two congruent base faces, which are parallel to each other and have a polygonal, in particular a triangular, shape or outline. Therein, the edges of the polygon or triangle may also be rounded but still be denoted as triangles or polygons. Such rounding may avoid edge effects due to light scattering and/or may be caused by manufacturing constraints. Furthermore, each prism comprises a plurality of joining faces which are, in particular, rectangular joining faces and connect the corresponding edges of the base faces. The number of joining faces is equal to the number of edges of the base faces. The joining faces are, in particular, perpendicular to the base faces. A longitudinal direction of a prism may be defined as a normal direction to the base faces, which is parallel to the joining faces.

In particular, the orientation of the prisms is the same for all of the prisms or, in other words, the longitudinal directions of all of the prisms of the array of prisms are parallel to each other. The longitudinal directions of the prisms are, in particular, parallel to the plane surface on the second side of the bending portion. For example, the optical device may comprise a substrate, which is designed as a pane with two opposite plane surfaces, where one of them forms the second side of the optical element and the prisms are arranged on the other side of the substrate. The non-bending portion may correspond to the pane of the substrate, for example.

The prisms and the optical element are, in particular, oriented with respect to the lens unit and the optical axis, respectively, of the camera such that the optical axis is parallel to the base faces of the prisms.

The plurality of prisms comprises three or more prisms. The total number of prisms may, for example, lie between 10 and 100,000 or several 100,000 s. For example, the number of prisms may be 50 to 100,000 prisms or 50 to 10,000 prisms. The actual number of prisms depends on the actual implementation, the field of view of the camera, the available assembly space, et cetera.

For example, all prisms of the array of prisms may be identical and form a one-dimensional array on the first side of the optical device. Alternatively, the prisms may have different sizes, but the aspect ratios of the respective edges of the base faces are identical. In other words, the base faces of all of the prisms may be linearly scaled to be congruent.

In particular, the plurality of prisms may be arranged in a periodic manner. In other words, the first side comprises a periodic structure forming the plurality of prisms or array of prisms.

In particular, the bending portion is essentially flat. This means that the width and the length of the bending portion are significantly larger than the thickness of the op bending portion, which is defined in a direction perpendicular to the plane surface of the second side. Therein, significantly larger may be understood such that the length and the width both are at least 10 times the thickness, in particular at least 100 times the thickness.

In particular, the non-bending portion as well as the bending portion, in particular the array of prisms and, if applicable, the substrate, are transparent for visible light, that is for light with a wavelength from 380 nm to 750 nm.

The non-bending portion as well as the bending portion, in particular the array of prisms and, if applicable, the substrate, may for example also be transparent for infrared light or infrared light in a specific range, for example near infrared light. In the latter case, the front camera arrangement can for example be used for corresponding infrared imaging application.

The prisms and/or the substrate may for example, comprise or consist of a plastic material, in particular a transparent plastic material, such as polymethylmethacrylate, PMMA, polydimethylglutarimide, PMGI, or polycarbonate, PC. The prisms and/or the substrate may, in other implementations also be made of glass.

The optical device may, for example, be connected to the camera or the lens unit directly or indirectly, that is via a further component of the camera. For example, the optical device may be a part of the camera or the lens unit and may, for example, be mounted within a lens housing of the lens unit. However, in other implementations, the optical device is provided separately from the camera and the lens unit and the optical device may be placed between the lens unit and the windshield. In particular, the first side of the bending portion faces the lens unit and the second side of the bending portion faces the windshield, in particular the interior surface of the windshield.

Using the array of prisms, in particular an array of micro-prisms, for the bending portion is particularly beneficial since such an array of prisms does not require a large amount of assembly space and may be fabricated with a low weight, which simplifies assembly and mounting of the front camera arrangement in the motor vehicle. Furthermore, due to the low weight, also keeping the optical device stable with respect to the camera is simplified.

According to several implementations, the bending portion comprises two or more sub-portions covering respective adjacent vertical segments of the second part of the vertical field of view. Each of the sub-portions is designed to, for a given propagation direction, in particular of incoming light, to increase the vertical angle the propagation direction includes with the direction of the optical axis by a respective amount of angular change.

In particular, the respective amount of angular change is different for each sub-portion. The different sub-portions may have differently structured surface parts, for example if the optical device is implemented as the metalens. In case the optical device is implemented such that the bending portion comprises the array of prisms, the different sub-portions correspond to different arrays of prisms. The explanations above carry over to each individual array of prisms wherein, however, the angles within the polygon or triangle of the base faces of the individual prisms may differ for different arrays such that different amounts of angular change are achieved.

In other implementations, each of the sub-portions comprises or consists of a single prism. Consequently, the bending portion consists of a single array of prisms formed by the single prisms of the sub-portions.

In particular, the single prisms of different sub-portions may lead to different amounts of angular change. This may be achieved for example by using prims with rectangular triangles as base faces but with different angles included by their respective hypothenuses with the plane surface.

According to several implementations, the two or more sub-portions are designed such that for each pair of adjacent vertical segments of the second part, the amount of angular change is greater for the respective vertical segment that is located further away from the non-bending portion.

In other words, the amount of angular change increases with the distance of the respective sub-portion from the non-bending portion. In this way, it is achieved that the distortion of the resulting image is still comparably small in the region close to the non-bending portion and increases gradually towards the outer boundaries of the vertical field of view of the front camera arrangement. in particular, a smoother transition of the different regions in the resulting image may be achieved.

According to several implementations, the front camera arrangement comprises a windshield for the motor vehicle. The optical device is mounted at an inner side of the windshield and the camera is mounted at the inner side of the windshield, such that the optical device is arranged between the windshield and the camera.

According to a further aspect of the invention also a motor vehicle comprising a front camera arrangement according to the invention is provided.

According to several implementations of the motor vehicle, the motor vehicle is a bus or a truck or a special vehicle (e.g. a forestry vehicle, a harvesting vehicle, a bulldozer or a caterpillar or any other heavy machinery or vehicle).

According to several implementations of the motor vehicle, a mounting height of the optical device on the motor vehicle is at least 1.4 m, in particular at least 2 m, in particular measured from the ground or street surface.

For example, the mounting height of the optical device may correspond to a height of a typical position of a head of a human driver of the vehicle or may be slightly larger (e.g. at least 1.4 m or at least 2 m), in particular measured from ground or street surface. Thus, it can be achieved that the front camera arrangement can detect at least within a range which is visible for the driver. This is particularly beneficial when safety relevant functions shall be carried out based on the camera images of the front camera arrangement.

Further features of the invention are apparent from the claims, the figures and the figure description. The features and combinations of features mentioned above in the description as well as the features and combinations of features mentioned below in the description of figures and/or shown in the figures may be comprised by the invention not only in the respective combination stated, but also in other combinations. In particular, embodiments and combinations of features, which do not have all the features of an originally formulated claim, may also be comprised by the invention. Moreover, embodiments and combinations of features which go beyond or deviate from the combinations of features set forth in the recitations of the claims may be comprised by the invention.

In the following, the invention will be explained in detail with reference to specific exemplary implementations and respective schematic drawings. In the drawings, identical or functionally identical elements may be denoted by the same reference signs. The description of identical or functionally identical elements is not necessarily repeated with respect to different figures.

In the figures,

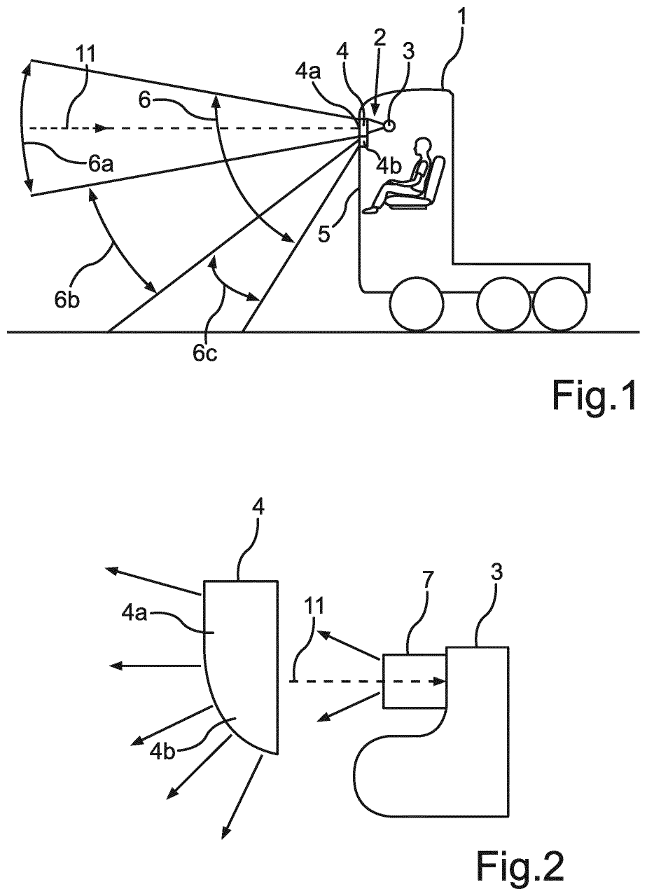

FIG. 1 shows schematically an exemplary implementation of a motor vehicle according to the invention;

FIG. 2 shows schematically an exemplary implementation of a front camera arrangement according to the invention;

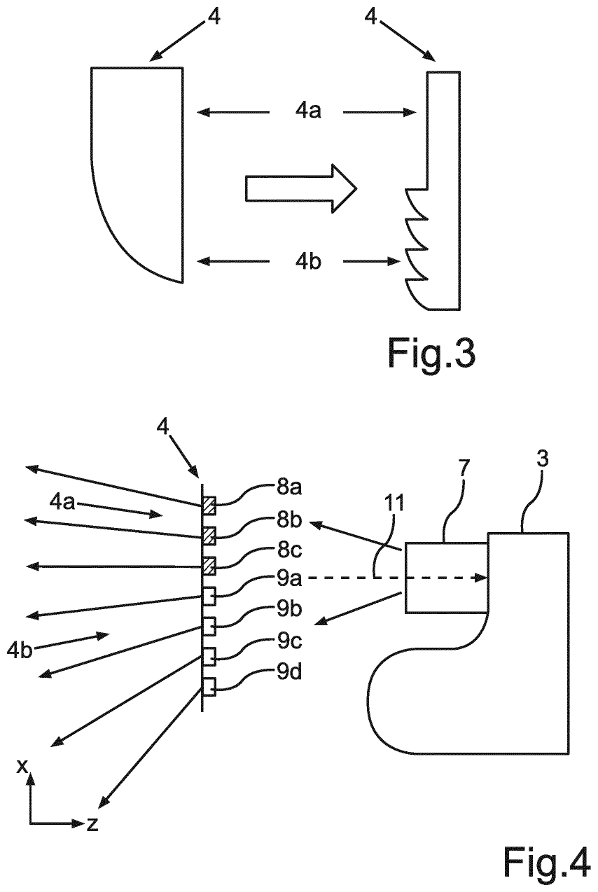

FIG. 3 shows schematically two different examples for an optical device in respective further exemplary implementations of a front camera arrangement according to the invention;

FIG. 4 shows a further exemplary implementation of a front camera arrangement according to the invention;

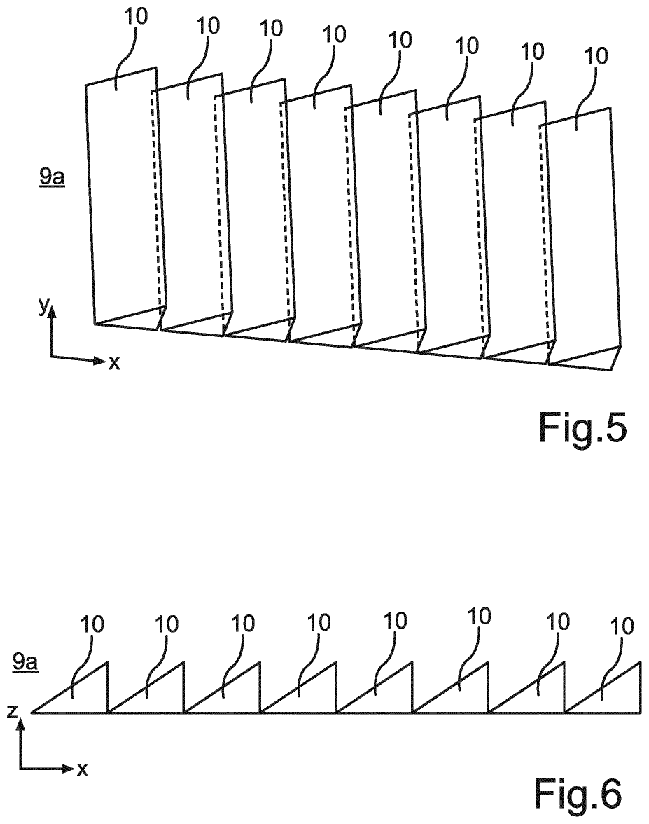

FIG. 5 shows an array of prisms for use in a further exemplary implementation of a front camera arrangement according to the invention in a perspective view;

FIG. 6 shows the array of prisms of FIG. 5 in a side view; and

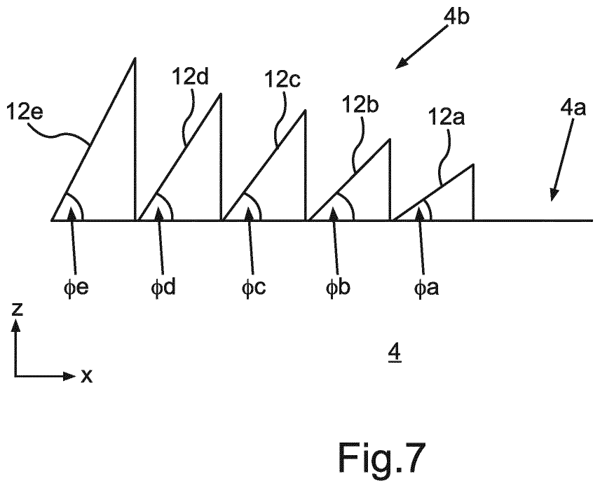

FIG. 7 shows an array of prisms for use in a further exemplary implementation of a front camera arrangement according to the invention in a side view.

FIG. 1 shows schematically an exemplary implementation of a motor vehicle 1 according to the invention, which comprises an exemplary implementation of a front camera arrangement 2 according to the invention. The front camera arrangement 2 is for example mounted at a windshield 5 of the motor vehicle 1, which is for example a truck, such that an optical device 4 of the front camera arrangement 2 is arranged between the windshield 5 and a camera 3 of the front camera arrangement 2.

The optical device 4 comprises a non-bending portion 4a, which is designed such as to leaves a propagation direction of light passing through the non-bending portion 4a unchanged. The optical device 4 comprises a bending portion 4b, which is designed and arranged with respect to the camera 3 such as to change a propagation direction of light passing through the bending portion 4b, wherein a vertical angle the propagation direction includes with a direction of an optical axis 11 of the camera 3 pointing towards an image sensor of the camera 3 is increased. The optical device 4 is arranged with respect to the camera 3 such that the non-bending portion 4a of the optical device covers a first part of a vertical field of view of the camera 3 and the bending portion of the optical device 4 covers a second part of the vertical field of view, which is adjacent to the first part of the vertical field of view.

FIG. 2 shows an exemplary implementation of the optical device 4 as well as the camera 3 with its lens unit 7. As can be seen in FIG. 2, in a section parallel to the vertical plane, the non-bending portion 4a may be given by a pane of glass or a plastic material with parallel surfaces facing the lens unit 7 and facing away from the lens unit 7, respectively. For example, a rear side of the pane may face the lens unit 7 and a front side of the pane may face away from the lens unit 7. The bending portion 4b, on the other hand, may for example have a plane surface facing the lens unit 7, while an opposite surface facing away from the lens unit 7 is curved as for a lens, for example as for a fisheye type lens. Consequently, light passing through the bending portion 4b has its vertical angle increased, wherein the amount of angular change is the greater, the further away from the non-bending portion 4a the light passes the bending portion 4b.

As shown schematically in FIG. 3, an analogous optical device 4 may also be formed according to the concept of a Fresnel lens, wherein the central portion of the Fresnel lens corresponding to the non-bending portion 4a has for example two parallel plane surfaces.

An alternative example for the optical device 4 is shown in FIG. 4. Therein, the optical device 4 comprises one or more non-bending segments 8a, 8b, 8c, which are for example formed by one or more panes with flat parallel surfaces. The bending portion 4b may comprise one or more arrays 9a, 9b, 9c, 9d of prisms 10, which are arranged below the segments 8a, 8b, 8c of the non-bending portion 4a that is, they are arranged closer to the road surface. An example for one of the arrays 9a of prisms 10 is shown in a perspective view in FIG. 5 and in a side view in FIG. 6.

Each prism 10 of the array 9a is for example designed as a triangular prism, in particular a right triangular prism with right angled base faces, as shown in FIG. 5 and FIG. 6. The prisms 10 are formed on a first side of the bending portion 4b and the bending portion 4b comprises a plane surface on a second side, which is opposite to the first side. The second side faces for example the windshield 5, while the first side faces the lens unit 7. The prisms 10 are arranged on the array 9a such that the rectangular triangles forming the base faces have a respective cathetus, which is parallel to the plane surface. In particular, the base faces of all prisms 10 of a given array 9a are congruent and their orientations are identical. On the other hand, the prisms 10 of different arrays 9a, 9b, 9c, 9d have, in general, non-congruent base faces. In particular, the prisms 10 may be designed such that the propagation direction of the light is changed least by the array 9a and the amount of change increases over the array 9b and 9c and is greatest for the array 9d being closest to the road surface.

The number of arrays 9 a, 9 b, 9 c, 9 d and the number of prisms 10 per array 9a, 9 b, 9 c, 9 d is not limited by the shown examples. Furthermore, additional implementations are obtained by replacing the arrays 9a, 9b, 9c, 9d by respective diffractive microstructured areas that have the same or a similar light bending effect as said prisms. In this way, the optical device 4 may be constructed even thinner.

An alternative example is shown in FIG. 7. Therein, the bending portion 4b comprises a single array of prisms 12a, 12b, 12c, 12d, 12e. The prisms 12a, 12b, 12c, 12d, 12e are formed on the first side of the bending portion 4b opposite to the plane surface. The prisms 12a, 12b, 12c, 12d, 12e are arranged such that the rectangular triangles forming their base faces have a respective cathetus, which is parallel to the plane surface. However, the prisms 12a, 12b, 12c, 12d, 12e have non-congruent base faces in this case. Rather, the respective hypothenuses of each prism's 12a, 12b, 12c, 12d, 12e base face includes a respective angle φₐ, φ_{b}, φ_{c}, φ_{d}, φₑ with said plane surface. The angle φₐ is smallest for the prism 12a adjacent to the non-bending portion 4a and increases the further away the respective prism is from the non-bending portion 4a, such that the angle φₑ is largest for the prism 12e.

The number of prisms 12a, 12b, 12c, 12d, 12e is not limited to the shown number of five prisms. It can, in particular, be a larger number to allow for a smaller angular change of neighboring prisms. Furthermore, additional implementations are obtained by replacing the arrays 12a, 12b, 12c, 12d, 12e by respective diffractive microstructured areas that have the same or a similar light bending effect as said prisms. In this way, the optical device 4 may be constructed even thinner.

As described, in particular with respect to the figures, the invention allows to extend a vertical field of view of a front camera arrangement for a motor vehicle such that a blind area in front of the vehicle is reduced.

In particular, the invention uses the optical device to divide the field of view into an unmodified area and an area where the light is optically bent in order to cover a greater field of view and to significantly reduce the dead or blind detection space in front of the vehicle. In this way, effectively an optical merging of the characteristics of a normal lens and a fisheye lens is achieved.

The optical device can be a flat or thin layer and may be implemented in different ways, for example in terms of one or more arrays of prisms, which may for example be 3D-printed using an optically transparent material, using a Fresnel type lens with a flat portion in the middle, or using a hybrid combination of a non-bending portion and a structured surface in a metalens.

1. A front camera arrangement for being mounted to a motor vehicle comprising a camera and an optical device, which is arranged in a field of view of the camera and wherein
the optical device comprises a non-bending portion, which is designed to leave a propagation direction of light passing through the non-bending portion unchanged;
the optical device comprises a bending portion, which is designed and arranged with respect to the camera to change a propagation direction of light passing through the bending portion, wherein a vertical angle the propagation direction includes with a direction of an optical axis of the camera pointing towards an image sensor of the camera is increased; and
the optical device is arranged with respect to the camera such that the non-bending portion of the optical device covers a first part of a vertical field of view of the camera and the bending portion of the optical device covers a second part of the vertical field of view, which is adjacent to the first part of the vertical field of view,
wherein the optical device is implemented as a metalens, and
wherein the bending portion corresponds to a portion of the metalens with a structured surface.

2. The front camera arrangement according to claim 1,
wherein the bending portion comprises an array of prisms.

3. The front camera arrangement according to claim 2,
wherein the prisms of the array of prisms are designed as triangular prisms.

4. The front camera arrangement according to claim 2,
wherein the prisms of the array of prisms are formed on a first side of the bending portion and the bending portion comprises a plane surface on a second side, which is opposite to the first side.

5. The front camera arrangement according to claim 4,
wherein each prism of the array of prisms comprises two base faces, which are perpendicular to the plane surface.

6. The front camera arrangement according to claim 5,
wherein the respective base faces of all prisms of the array of prisms are parallel to each other.

7. The front camera arrangement according to claim 5,
wherein the base faces of all prisms of the array of prisms are designed as rectangular triangles having a respective cathetus, which is parallel to the plane surface.

8. The front camera arrangement according to claim 7,
wherein the base faces of all prisms of the array of prisms are congruent and their orientations are identical.

9. The front camera arrangement according to claim 1,
wherein the bending portion comprises two or more sub-portions covering respective adjacent vertical segments of the second part of the vertical field of view; and
for a given propagation direction, each of the sub-portions is designed to increase the vertical angle the propagation direction includes with the direction of the optical axis by a respective amount of angular change.

10. The front camera arrangement according to claim 9,
wherein the two or more sub-portions are designed such that for each pair of adjacent vertical segments of the second part, the amount of angular change is greater for the respective vertical segment that is located further away from the non-bending portion.

11. The front camera arrangement according to claim 1,
wherein the front camera arrangement comprises a windshield for the motor vehicle;
wherein the optical device is mounted at an inner side of the windshield; and
the camera is mounted at the inner side of the windshield, such that the optical device is arranged between the windshield and the camera.

12. The motor vehicle comprising a front camera arrangement according to claim 1.

13. The motor vehicle according to claim 12,
wherein the motor vehicle is a bus or a truck or a special vehicle; and/or
a mounting height of the optical device on the motor vehicle is at least 1.4 m.
